(19) United States
(12) Patent Application Publication
(10) Pub. No.: US 2025/0178475 A1
(43) Pub. Date: Jun. 5, 2025

(54) METHOD FOR PROVIDING BATTERY REPLACEMENT SERVICE, SERVICE SERVER, AND MOBILITY

(71) Applicants: Hyundai Motor Company, Seoul (KR); Kia Corporation, Seoul (KR)

(72) Inventor: Jeong Min Moon, Hwaseong-si (KR)

(21) Appl. No.: 18/950,489

(22) Filed: Nov. 18, 2024

(30) Foreign Application Priority Data
Dec. 4, 2023 (KR) 10-2023-0173599

(51) Int. Cl. B60L 53/80; B60L 58/16

(52) U.S. Cl. CPC B60L 53/80; B60L 58/16

(57) ABSTRACT

In a method for providing a battery replacement service that provides a second swappable battery to replace a first swappable battery for a mobility, where the mobility can include a plurality of wheels, at least one driving motor configured to provide driving force to the plurality of wheels, a power system configured to supply power to the driving motor, and the first swappable battery detachably connected to the power system, the method can include: receiving a service request from a user terminal by a service server; transmitting a list of available swappable batteries to the user terminal by the service server according to the service request; and receiving selection of one of the batteries in the list from the user terminal and determining the second swappable battery according to the received selection by the service server.

### CROSS-REFERENCE TO RELATED APPLICATIONS

The present application claims priority to Korean Patent Application No. 10-2023-0173599, filed on Dec. 4, 2023, the entire contents of which is incorporated herein for all purposes by this reference.

### TECHNICAL FIELD

The present disclosure relates to a method for providing a battery replacement service, a service server therefor, and a mobility.

### BACKGROUND

In general, an electric vehicle that is a kind of mobilities travels as wheels are driven by driving force of a driving motor.

Also, in general, a high-voltage battery is fixedly mounted to the vehicle to supply power to the driving motor.

The driving motor may be an AC motor, and due to this, an inverter may be disposed between the battery and the driving motor.

The battery of the electric vehicle is charged by receiving external power through an on board charger (OBC) when charging is required according to a charge state thereof, i.e., a state of charge (SoC).

A charging time may be determined according to a charging method and largely divided into slow charging and fast charging.

In recent years, continuing research and development on batteries helps to significantly improve a driving range per one charge.

However, the battery fixedly mounted to the electric vehicle has a limit to satisfy a customer's demand for a longer driving range, and the charging still requires a significant amount of time although the charging time is gradually reduced with the help of development of charging technology. Thus, an alternative thereof is needed.

### SUMMARY

An embodiment of the present disclosure can relieve or solve at least one of limitations of the related art.

An embodiment of the present disclosure can provide a new concept technology of using a second high-voltage swappable battery that may be added to and separated from a power system of an electric vehicle as needed in addition to a first high-voltage battery that is a battery (hereinafter, referred to as a built-in battery) fixedly mounted to the electric vehicle.

An embodiment of the present disclosure can provide an electric vehicle including a first high-voltage battery that is swappable with a fully charged battery when discharged instead of being fixedly mounted.

An embodiment of the present disclosure can provide a business method, an electric vehicle, and a server for the above-described battery replacement.

In general, a battery has a characteristic in which a state of health (SOH) can be degraded due to aging of battery cells when charging and discharging are repeated, and the maximum charging capacity of the battery can be proportional to the SOH. Thus, an old swappable battery having a decreased SOH can provide a relatively short maximum traveling distance to a service user, and this may cause reduction in business competitiveness or increase in business cost caused by battery replacement for a business operator of a battery replacement service.

When SOH information of the battery is not provided to a user of the replacement service, because the maximum traveling distance can be varied according to the SOH although the SOC of the battery is 100%, the user may have dissatisfaction due to a feeling of an unequal service quality.

Also, when the SOH information is provided to the user, but a cost is not varied although the SOH is different, the user may prefer a battery having a high SOH, and this may reduce the usage rate of the old battery to decrease the profit of the business operator.

Thus, an embodiment of the present disclosure can provide a business method in which the cost for a battery can vary according to the SOH thereof, a server, and an electric vehicle capable of using the above-described service to relieve or solve the above-described limitation.

An embodiment of the present disclosure can provide a method for providing a battery replacement service that provides a second swappable battery to be replaced with a first swappable battery to a mobility including a plurality of wheels, at least one driving motor configured to provide driving force to the plurality of wheels, a power system configured to supply power to the driving motor, and a first high-voltage swappable battery detachably connected to the power system, the method can include: receiving, by a service server, a service request from a user terminal; transmitting, by the service server, a list of available swappable batteries to the user terminal according to the service request; and receiving, by the service server, selection of one of the available swappable batteries in the list from the user terminal and determining the second swappable battery according to the received selection.

In an embodiment of the present disclosure, the transmitting of the list of the available swappable batteries to the user terminal may include determining a cost for each of the available swappable batteries based on a state of health (SOH) thereof, and allowing the determined cost to be included in the list of the swappable batteries.

In an embodiment of the present disclosure, the determining of the cost may include determining the cost to be decreased linearly as the SOH is decreased.

In an embodiment of the present disclosure, the determining of the cost to be decreased linearly as the SOH is decreased may include: determining a minimum cost by using a preset first SOH, a preset SOH limit, a preset maximum cost, and a preset charging cost, and determining the cost by decreasing the cost linearly from the preset maximum cost to the minimum cost as the SOH is decreased.

In an embodiment of the present disclosure, the service request may include destination information, and the transmitting of the list of the swappable batteries to the user terminal can include: determining a traveling distance according to the destination information; and determining the available swappable batteries according to the traveling distance.

In an embodiment of the present disclosure, the power system may include a first high-voltage battery that is fixedly installed on the mobility, the first swappable battery may include a second high-voltage battery that is detachably connected to the power system to supply power to the first high-voltage battery, and the determining of the available swappable batteries according to the traveling distance may include determining the available swappable batteries based on an SOC of the first high-voltage battery.

In an embodiment of the present disclosure, the first swappable battery may include a first high-voltage battery that is detachably connected to the power system to supply power to the at least one driving motor, and the determining of the available swappable batteries according to the traveling distance may include determining swappable batteries that satisfy the traveling distance as the available swappable batteries.

In an embodiment of the present disclosure, the list of the available swappable batteries may include a SOH, a traveling distance, and a cost for each swappable battery.

In an embodiment of the present disclosure, a service server of a battery replacement service can be provided, which can provide a second swappable battery to be replaced with a first swappable battery to a mobility including a plurality of wheels, at least one driving motor configured to provide driving force to the plurality of wheels, a power system configured to supply power to the driving motor, and a first high-voltage swappable battery detachably connected to the power system, the server comprising a memory in which a computer program for the battery replacement service is stored, and a processor configured to execute the computer program, such that, as the computer program is executed by the processor, the server can be configured to receive a service request from a user terminal, to transmit a list of available swappable batteries to the user terminal according to the service request, to receive selection of one of the available swappable batteries in the list from the user terminal, and to determine the second swappable battery according to the received selection.

In an embodiment of the present disclosure, the transmitting of the list of the swappable batteries to the user terminal may include: determining a cost for each of the available swappable batteries based on a state of health (SOH) thereof, and allowing the determined cost to be included in the list of the swappable batteries.

In an embodiment of the present disclosure, the determining of the cost may include determining the cost to be decreased linearly as the SOH is decreased.

In an embodiment of the present disclosure, the determining of the cost to be decreased linearly as the SOH is decreased may include: determining a minimum cost by using a preset first SOH, a preset SOH limit, a preset maximum cost, and a preset charging cost; and determining the cost by decreasing the cost linearly from the preset maximum cost to the minimum cost as the SOH is decreased.

In an embodiment of the present disclosure, the service request may include destination information, and the transmitting of the list of the swappable batteries to the user terminal may include: determining a traveling distance according to the destination information; and determining the available swappable batteries according to the traveling distance.

In an embodiment of the present disclosure, the power system may include a first high-voltage battery that is fixedly installed on the mobility, the first swappable battery may include a second high-voltage battery that is detachably connected to the power system to supply power to the first high-voltage battery, and the determining of the available swappable batteries according to the traveling distance may include determining the available swappable batteries based on an SOC of the first high-voltage battery.

In an embodiment of the present disclosure, the first swappable battery may include a first high-voltage battery that is detachably connected to the power system to supply power to the at least one driving motor, and the determining of the available swappable batteries according to the traveling distance may include determining swappable batteries that satisfy the traveling distance as the available swappable batteries.

In an embodiment of the present disclosure, the list of the available swappable batteries may include a SOH, a traveling distance, and a cost for each swappable battery.

In an embodiment of the present disclosure, a mobility can include a plurality of wheels, at least one driving motor can be configured to provide driving force to the plurality of wheels, a power system can be configured to supply power to the driving motor, a first high-voltage swappable battery can be detachably connected to the power system, a user interface, a wireless communication module; and a first controller can be configured to communicate with a service server for a battery replacement service through the wireless communication module according to an input of a user through the user interface, and the first controller can be configured to transmit a service request to the service server according to the input of the user through the user interface, receive a list of available swappable batteries from the service server, and transmit selection of one of the available swappable batteries in the list selected through the user interface by the user to the service server.

In an embodiment of the present disclosure, the power system may include a first high-voltage battery that is fixedly installed on the mobility, and the first swappable battery may include a second high-voltage battery that is detachably connected to the power system to supply power to the first high-voltage battery.

In an embodiment of the present disclosure, the first swappable battery may include a first high-voltage battery that is detachably connected to the power system to supply power to the at least one driving motor.

In an embodiment of the present disclosure, the list of the available swappable batteries may include a SOH, a traveling distance, and a cost for each swappable battery.

### BRIEF DESCRIPTION OF THE DRAWINGS

It can be understood that the appended drawings are not necessarily to scale, presenting a somewhat simplified representation of various features illustrative of principles by example embodiments of the present disclosure. The specific design features of an embodiment of the present disclosure as included herein, including, for example, specific dimensions, orientations, locations, and shapes can be determined in part by the particularly intended application and use environment.

In the figures, same reference numerals can refer to same or equivalent parts of one or more example embodiments of the present disclosure throughout the several figures of the drawing.

FIG. 1 is a schematic view illustrating an example of a power system of a first mobility according to an embodiment of the present disclosure.

FIG. 2 is a schematic view illustrating a state in which the first mobility is connected to a second mobility according to an embodiment of the present disclosure.

FIG. 3 is a schematic view illustrating an example of a power system of a mobility according to an embodiment of the present disclosure.

FIG. 4 is a schematic view illustrating a situation of a battery replacement service performed through a communication between a battery station and a mobility according to an embodiment of the present disclosure.

FIG. 5 is a flowchart representing a method for providing a batter replacement service according to an embodiment of the present disclosure.

FIG. 6 is a graph illustrating an example of a method for calculating a service cost according to an embodiment of the present disclosure.

### DETAILED DESCRIPTION OF ILLUSTRATIVE EMBODIMENTS

Reference will now be made in detail to various example embodiments of the present disclosure, which are illustrated in the accompanying drawings and described below. While example embodiments of the present disclosure will be described, it can be understood that the present description is not intended to be necessarily limited by the example embodiments of the present disclosure. On the other hand, the present disclosure is intended to cover not only the example embodiments of the present disclosure, but also various alternatives, modifications, equivalents, and other embodiments, which may be included within the spirit and scopes of the present disclosure as defined by the appended claims.

Because an embodiment of the present disclosure can be modified in various ways and there can be various embodiments of the present disclosure, specific example embodiments will be illustrated and described in the drawings. However, this is not intended to necessarily limit the present disclosure to specific example embodiments, and it can be understood that the present disclosure includes all modifications, equivalents, and replacements included on the ideas and technical scopes of the present disclosure.

The suffixes “module” and “unit” used herein can be used merely for name distinction between elements and should not be necessarily construed as being physiochemically divided or separated or assumed that they may be divided or separated.

Terms including ordinals such as “first,” “second,” and the like may be used to describe various elements, but the elements are not necessarily limited by such terms. Such terms can be used merely for distinguishing one element from another element.

The term “and/or” can be used to include any combination of a plurality of items to be included. For example, “A and/or B” can include all three cases such as “A”, “B”, and “A and B”.

When an element is “connected” or “linked” to another element, it can be understood that the element may be directly connected or connected to another element, but another element may exist in between.

The terminology used herein is for describing various example embodiments and is not intended to be necessarily limiting of the present disclosure. Singular expressions can include plural expressions, unless the context clearly indicates otherwise. In the present application, it can be understood that the term “include” or “have” indicates that a feature, a number, a step, an operation, a component, a part, or a combination thereof described in the specification is present, but does not exclude the possibility of existence or addition of one or more other features, numbers, steps, operations, components, parts, or combinations thereof in advance.

Unless otherwise defined, terms used herein, including technical or scientific terms, can include a same meaning as that generally understood by those skilled in the art. It can be understood that terms, such as those defined in commonly used dictionaries, can be interpreted as including a meaning that is consistent with their meaning in the context of the relevant art.

Furthermore, the term “unit” or “control unit” can be used for naming a controller that commands a specific function, rather than a generic function unit. For example, each unit or control unit may include a communication device communicating with another controller or sensor, a computer-readable recording medium storing an operating system or a logic command, input/output information, and the like, to control a function in charge, and one or more processors performing calculation, comparison, determination, and the like for controlling a function in charge.

For example, a system by these names may include a communication system that communicates with another controller or sensor to control a corresponding function, a computer-readable recording medium that stores an operating system or logic command, input/output information, etc., and one or more processors that perform calculation, comparison, determination, and the like for controlling the corresponding function.

The processor may include a semiconductor integrated circuit and/or electronic systems that perform at least one or more of comparison, determination, and calculation to achieve a programmed function. For example, the processor may be one of a computer, a microprocessor, a CPU, an ASIC, and a circuitry (logic circuits), or a combination thereof.

Furthermore, the computer-readable recording medium (or simply referred to as a memory) can include all types of storage devices in which data can be stored and may be read by a computer system. For example, a memory may include at least one type of a flash memory of a hard disk, of a microchip, of a card (e.g., a secure digital (SD) card or an eXtream digital (XD) card), etc., and at least a memory type of a Random Access Memory (RAM), of a Static RAM (SRAM), of a Read-Only Memory (ROM), of a Programmable ROM (PROM), of an Electrically Erasable PROM (EEPROM), of a Magnetic RAM (MRAM), of a magnetic disk, and of an optical disk, or any combination thereof.

The recording medium may be electrically connected to the processor, and the processor may retrieve and record data from the recording medium. The recording medium and the processor may be integrated or may be physically separated.

Hereinafter, the accompanying drawings will be briefly described, and example embodiments of the present disclosure will be described in detail with reference to the drawings.

First, although a mobility includes an electric vehicle in this example embodiment, an embodiment of the present disclosure is not necessarily limited thereto. In this example embodiment, the mobility can refer to a transportation unit including a battery as at least a portion of a power source thereof.

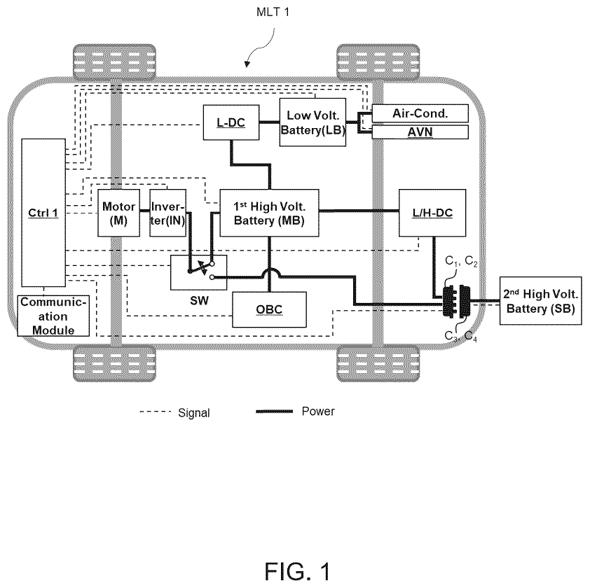

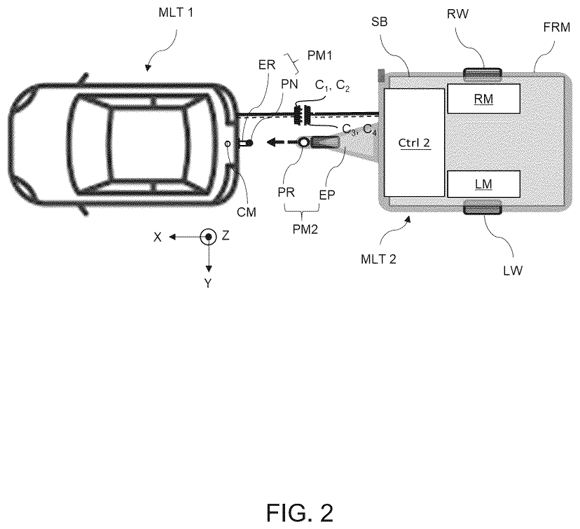

FIG. 1 is a conceptual view illustrating a power system of a first mobility MLT 1 according to an embodiment of the present disclosure. FIG. 2 is a view illustrating a state in which a second mobility MLT 2 is connected to the first mobility MLT 1.

Each of structures of the first mobility MLT 1 and the second mobility MLT 2 according to an embodiment of the present disclosure will be described with reference to FIGS. 1 and 2.

As illustrated in FIG. 1, the first mobility MLT 1 according to an embodiment of the present disclosure can be, e.g., an electric vehicle and can include a first driving motor M, an inverter IN, a first high-voltage battery MB, an on board charger OBC, a first DC/DC converter L-DC, a low-voltage battery LB, a low-voltage air-conditioner Air-Cond and an audio video navigation AVN, which can operate with a low-voltage, a second DC/DC converter L/H-DC, a switch SW, and a controller Ctrl 1 (hereinafter, referred to as a first controller), any combination of or all of which may be in plural or may include plural components thereof.

The first driving motor M can provide driving force to wheels (first wheels) of the vehicle. The first driving motor M may be, e.g., an alternating current motor.

The inverter IN can convert direct current power supplied to the first driving motor M into alternating current.

The first high-voltage battery MB may be a built-in battery fixedly mounted to a body, e.g., under cabin floor, of the first mobility MLT 1.

The first high-voltage battery MB may have a main function of supplying electric power to the first driving motor M and charged with the on board charger OBC.

Also, the first high-voltage battery MB may be connected to the low-voltage battery LB through the first DC/DC converter L-DC to charge the low-voltage battery LB.

The first DC/DC converter L-DC may be a low-voltage DC-DC converter to charge the low-voltage battery LB.

The low-voltage battery LB may be, e.g., a 12 V or 24 V battery. The low-voltage battery LB can supply electric power to an electrical device in the vehicle, such as an air conditioner or AVN that operates at a low voltage.

Although the second high-voltage battery SB illustrated in FIG. 1 can be installed on the second mobility MLT 2 of FIG. 2, an embodiment of the present disclosure is not necessarily limited thereto. For example, the second high-voltage battery SB may be detachably installed on the first mobility. That is, the second high-voltage battery SB may be replaced to the first mobility MLT 1 in a state of being mounted on the second mobility MLT 2 of FIG. 2 or replaced in a method of being directly mounted to the first mobility MLT 1 without the second mobility MLT 2.

The second high-voltage battery SB may be electrically connected additionally to a vehicle power system including the first high-voltage battery MB, i.e., in a separably wired method (or a wireless method in an allowable range) that has no effect on an operation of the power system (power supply to vehicle electronic components such as a driving motor).

Also, although the second high-voltage battery SB may be referred to as a swappable battery, auxiliary battery, extended battery, or second or secondary battery, this can be merely for being differentiated from the first high-voltage battery MB. That is, all sorts of features of the second high-voltage battery SB, such as a function, characteristics, a mechanical/electrical/chemical structure according to a relationship with other objects (including the first high-voltage battery MB and a host vehicle), a battery type (including the kinds of packaging method, positive electrode material/negative electrode material/separation membrane material), and a charging method, are not necessarily limited by a name of the second high-voltage battery SB.

The second high-voltage battery SB may be connected to a first controller Ctrl 1 of the first mobility MLT 1 or a battery management system (BMS) of the first high-voltage battery MB, which will be described later, in a wired or wireless manner. Through this, all sorts of sensing information (e.g., voltage, current, temperature, etc.) related to a SoC state and a physical/electrical/chemical state of the second high-voltage battery SB can be transmitted to the first controller Ctrl 1. However, an embodiment of the present disclosure is not necessarily limited thereto. For example, the above-described information related to the second high-voltage battery SB may be transmitted to the first controller Ctrl 1 through a second controller Ctrl 2 of the second mobility MLT 2 (see, e.g., FIG. 2), which will be described later.

In an embodiment, a high-voltage battery can be applied to the first high-voltage battery MB and the second high-voltage battery SB may include a plurality of battery cells (not shown) that output a voltage of, e.g., 2.7 V to 4.2 V, and the number of the plurality of battery cells to be connected in series or parallel may be set or selected, so that the plurality of battery cells form or act as one module. The high-voltage battery may be packaged such that one or more battery modules are connected in series or parallel as one battery to output, e.g., about 400 V, about 800 V, or several kV.

Each of the first high-voltage battery MB and the second high-voltage battery SB may include a battery management system (BMS).

The BMS may include a battery management unit (BMU), a cell monitoring unit (CMU), and a battery junction box (BJB).

The BMS can perform a cell balancing function of maintaining a voltage of each of cells constant, thereby ensuring a performance of an entire battery pack, a SoC function of calculating a capacity of an entire battery system, and battery cooling, charging, and discharging control.

The BMU can receive information on all cells from the CMU and perform the functions of the BMS based on the received information.

The BMU may include, e.g., two micro control units (MCU), and each of the MCUs may have one CAN communication port. The BMU may further include a CAN interface to communicate with a vehicle controller that can be a device at an upper hierarchy level of the BMS and a CAN interface to collect information from the CMU that can be a device at a lower hierarchy level of the BMS.

The CMU may be attached directly to the battery cell to sense a voltage, a current, and a temperature. The CMU may serve to perform sensing only instead of performing a calculation related to a BMS algorithm. One CMU may be formed by connecting a plurality of battery cells and transmit information of each of the cells to the BMU through the CAN interface.

A BJB can be a pack-level sensing mechanism of the BMS and a connection medium between the high-voltage battery and a drivetrain. For accurately calculating the SoC, a battery voltage and a current flowing into and out of the battery can be measured and recorded. Also, the BJB may perform an important function in safety, such as insulation monitoring in addition to overcurrent detection.

The second high-voltage battery SB may be a high-voltage battery having a voltage less than that of the first high-voltage battery MB, and in this case, the second DC/DC converter L/H-DC may be a DC/DC step-up converter. The second high-voltage battery SB may be a high-voltage battery having a voltage greater than that of the first high-voltage battery MB, and in this case, the second DC/DC converter L/H-DC may be a DC/DC step-down converter. Also, in an embodiment, the second DC/DC converter L/H-DC may be a bidirectional converter, and thus, the first high-voltage battery MB and the second high-voltage battery SB may charge and discharge each other.

In an embodiment, although the second DC/DC converter L/H-DC can be included as a built-in component of the first mobility MLT 1 in the power system, an embodiment of the present disclosure is not necessarily limited thereto. For example, the second DC/DC converter L/H-DC may be provided as a separate component and additionally and detachably connected to the power system. Also, the second DC/DC converter L/H-DC may be built-in or detachably included in the second mobility MLT 2.

In an embodiment, the power system of the first mobility MLT 1 may include first and second connectors C1 and C2, and the second high-voltage battery SB may include third and fourth connectors C3 and C4 for a separable electrical connection to the power system of the second high-voltage battery SB.

For example, each of the first and second connectors C1 and C2 may be an integrated connector, and each of the third and fourth connectors C3 and C4 may be also an integrated connector.

The first connector C1 may be connected to the second DC/DC converter L/H-DC, and the second connector C2 may be connected to the switch SW.

Although not shown, a signal transmission connector may be added to transmit all sorts of sensing and state information of the second high-voltage battery SB to the controller.

The switch SW can be fixedly electrically connected to the inverter IN and switched between the first high-voltage battery MB and the second connector C2 to electrically connect the inverter IN and the first high-voltage battery MB or the inverter IN and the second high-voltage battery SB.

In an embodiment, although the first high-voltage battery MB can be connected to the inverter IN through a switch SW, an embodiment of the present disclosure is not necessarily limited thereto. For example, the first high-voltage battery MB may be directly connected to the inverter IN without the switch SW. Also, in such case, the second connector and the fourth connector of the second high-voltage battery SB may not be required.

In an embodiment, although the first controller Ctrl 1 may be a vehicle controller at an uppermost hierarchy level, which can control all electric devices of the first mobility MLT 1, an embodiment of the present disclosure is not necessarily limited thereto. That is, for example, the first controller Ctrl 1 in FIG. 1 may be a power controller at a lower hierarchy level of the vehicle controller.

Also, in an embodiment, as described above, the first controller Ctrl 1 may include a computer-readable recording medium that stores an operation system, a logic command, and input/output information and at least one processor that reads the above-described stored system, command, and information to perform a decision or calculation required for function control.

The second high-voltage battery SB in FIG. 1 may be installed in the second mobility MLT 2 as illustrated in FIG. 2.

The second mobility MLT 2 can include a frame FRM, a second left wheel LW disposed at a left side of the frame FRM, a second right wheel RW disposed at a right side of the frame FRM, a second left driving motor LM providing driving force to the second left wheel LW, a second right driving motor RM providing driving force to the second right wheel RW, and a second controller Ctrl 2.

Although the second high-voltage battery SB may be fixedly installed on the second mobility MLT 2, an embodiment of the present disclosure is not necessarily limited thereto. That is, the second high-voltage battery SB may be detachably installed on the second mobility MLT 2. Through this, the second high-voltage battery SB can be mounted to the frame FRM with a completely discharged SoC state may be removed and replaced with a new second high-voltage battery SB in a fully charged SoC state.

When the second high-voltage battery SB is fixedly installed on the second mobility MLT 2, the second mobility MLT 2 may include a charging connector for charging the second high-voltage battery SB.

The frame FRM can form an appearance of the second mobility MLT 2 and serve to accommodate other components.

The frame FRM may include a second pivot mechanism PM2 that is a second connection mechanism, and the second pivot mechanism PM2 may be separably pivot-connected to a first pivot mechanism PM1 that is a first connection mechanism fixed to a body of the first mobility MLT 1.

For example, the first pivot mechanism PM1 can include an extension rod ER extending rearward from the body of the first mobility MLT 1 and a pivot pin PN protruding upward from an end of the extension rod ER.

Also, the second pivot mechanism PM2 can include an extension part EP having a triangular shape protruding forward from the frame FRM of the second mobility MLT 2 and a pivot ring PR that is disposed at an end of the extension part EP and to which the pivot pin PN can be rotatably inserted.

The pivot pin PN may perform a restricted linear movement in a state of being inserted to the pivot ring PR and only perform a rotation in a Z-axis direction of FIG. 2. Thus, in the pivot-connected state, the second mobility MLT 2 may be restricted in linear movement using a pivot connection point as a center with respect to the first mobility MLT 1 and only rotate about a Z axis.

When the second mobility MLT 2 travels in a forward direction, i.e., an X-axis direction of FIG. 2, each of the first mobility MLT 1 and the second mobility MLT 2 may maintain straightness thereof without separate steering control.

In an embodiment, although the pivot mechanism can be included as the first and second connection mechanisms, an embodiment of the present disclosure is not necessarily limited thereto. For example, the first and second connection mechanisms may be well-known mechanisms that realize non-rotational connection about the Z-axis.

The second left driving motor LM can have a rotation shaft that is connected to the second left wheel LW, and through this, the second left driving motor LM can provide driving force to the second left wheel LW.

Also, the second right driving motor RM can have a rotation shaft that is connected to the second right wheel RW, and through this, the second right driving motor RM can provide driving force to the second right wheel RW.

Because the second left wheel LW and the second right wheel RW can be connected to the second left driving motor LM and the second right driving motor RM, respectively, the second left wheel LW and the second right wheel RW may be driven independently from each other.

Because each of the second left driving motor LM and the second right driving motor RM may be driven in forward and backward directions, when driven in the forward direction, the second mobility MLT 2 travels forward, and when driven in the backward direction, the second mobility MLT 2 travels backward.

For example, although each of the second left driving motor LM and the second right driving motor RM may be realized as an in-wheel drive system in which each driving motor is installed in the wheel, an embodiment of the present disclosure is not necessarily limited thereto.

Also, the second mobility MLT 2 may be driven in such a manner that power of one common motor is distributed to the second left wheel LW and the second right wheel RW instead of independent driving of the left and right wheels. A differential gear may be included between the common second driving motor and the second left and right wheels LW and RW. The power of the common second driving motor may be distributed by the differential gear and transmitted to the second left wheel LW and the second right wheel RW. In such case, a torque vectoring unit may be added for torque distribution between the second left wheel LW and the second right wheel RW.

In FIG. 2, the second controller Ctrl 2 can control the second left driving motor LM and the second right driving motor RM to perform forward and backward traveling of the second mobility MLT 2. Also, when steering the second mobility MLT 2, the second controller Ctrl 2 may change a traveling direction through controlling torques or the number of rotation of each of the second left driving motor LM and the second right driving motor RM. That is, the steering of the second mobility MLT 2 can be performed without a separate steering device through independent control of the driving of the second left driving motor LM and the second right driving motor RM.

Also, as described above, the connectors and the wired or wireless communication unit for transmitting information between the first mobility MLT 1 and the second mobility MLT 2 in FIG. 1 can be included.

In an embodiment, the first controller Ctrl 1 and/or the second controller Ctrl 2 may include a memory and a processor, either or both of which may be in plural or may include plural components thereof. The memory can store computer commands for performing functions of the corresponding controller, and the processor can perform the above-described functions by reading and executing the commands from the memory.

For example, the memory can include at least one of a hard disk drive (HDD), a solid-state drive (SDD), a silicon disk drive (SDD), ROM, RAM, CD-ROM, a magnetic tape, a floppy disk, or an optical data storage device, or any combination thereof.

Also, for example, the processor can include at least one of a computer, a microprocessor, a central processing unit (CPU), an ASIC, an electric circuit, or a logic circuit, or any combination thereof.

As the first connector C1 and second connector C2 of the first mobility MLT 1 and the third connector C3 and fourth connector C4 of the second mobility MLT 2 are connected, the first mobility MLT 1 and the second mobility MLT 2, i.e., the first controller Ctrl 1 and the second controller Ctrl 2, may communicate with each other.

When the first mobility MLT 1 initiates to travel forward in a state in which the first mobility MLT 1 and the second mobility MLT 2 are mechanically and electrically connected, according to a traveling speed signal transmitted from the first connector C1, the second controller Ctrl 2 can control the second left driving motor LM and the second right driving motor RM to perform a forward straight traveling of the second mobility MLT 2.

Some or all of a speed, a gear position, a steering angle, accelerator pedal sensor (APS) information, and brake pedal sensor (BPS) information of the first mobility MLT 1 may be transmitted to the second mobility MLT 2.

The second controller Ctrl 2 of the second mobility MLT 2 may determine whether the first mobility MLT 1 is in a forward traveling state or a backward traveling state by using, e.g., some or all of the speed, the gear position, the APS information, and the BPS information of the first mobility MLT 1. However, an embodiment of the present disclosure is not necessarily limited thereto. For example, the second controller Ctrl 2 may directly receive information on whether the first mobility MLT 1 is in the forward traveling state or the backward traveling state from the first controller Ctrl 1.

When the first mobility MLT 1 travels forward, the second controller Ctrl 2 can drive the second left driving motor LM and the second right driving motor RM in the forward direction to perform the forward traveling of the second mobility MLT 2. When the first mobility MLT 1 travels backward, the second controller Ctrl 2 can drive the second left driving motor LM and the second right driving motor RM in the backward direction to perform the backward traveling of the second mobility MLT 2.

Also, the second controller Ctrl 2 may determine a steering state through steering angle information of the first mobility MLT 1 and perform steering of the second mobility MLT 2 based on the determined steering state.

The second mobility MLT 2 may not include a separate steering device such as a steering wheel and a steering rack and may perform the steering through torque control of the second left driving motor LM and the second right driving motor RM.

The second controller Ctrl 2 may calculate traveling torque for traveling and steering torque for steering for each of the second left driving motor LM and the second right driving motor RM and use the calculated torque for control.

For example, a lookup table or calculation program may include steering torque values of the second left driving motor LM and the second right driving motor RM according to the steering angle of the first mobility MLT 1 to perform steering of the second mobility MLT 2

When travels forward, the second mobility MLT 2 may be controlled to travel at a speed equal to or less than that of the first mobility MLT 1. Through this, the pivot connection between the first mobility MLT 1 and the second mobility MLT 2 may be maintained within a predetermined pivot angle range. For example, when the speed of the second mobility MLT 2 is controlled equal to or less than that the first mobility MLT 1 during the forward straight traveling, a pivot angle of the second mobility MLT 2 with respect to the first mobility MLT 1 at a pivot connection point may maintain 0° (which represents an angle at which the first mobility MLT 1 and the second mobility MLT 2 are on a straight line).

The second mobility MLT 2 may be controlled to follow the first mobility MLT 1, and through this, a plurality of mobilities may be smoothly connected to travel.

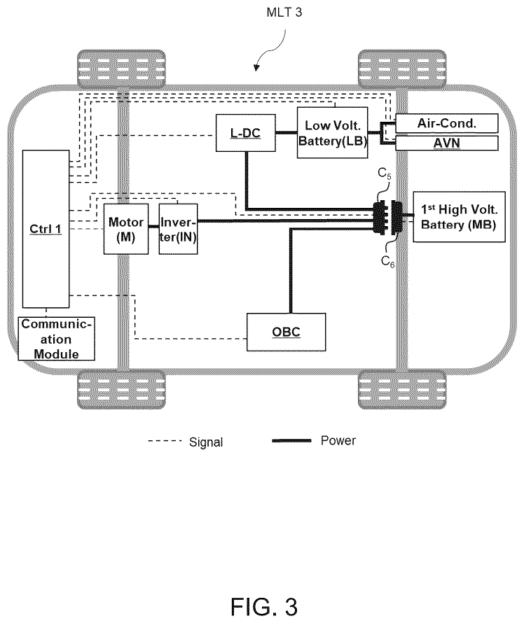

FIG. 3 is a view illustrating a third mobility MLT 3 according to an embodiment of the present disclosure, and hereinafter will be described in detail.

In an embodiment, a first high-voltage battery MB can be a swappable battery instead of a built-in battery, which can be different from the example embodiment of FIG. 1, and this difference will be mainly described.

A power system of the third mobility MLT 3 in FIG. 3 can include a first DC/DC converter L-DC, an inverter IN, an on board charger OBC, and a fifth connector C5, any combination of or all of which may be in plural or may include plural components thereof.

The fifth connector C5 can be connected to the inverter IN, the on board charger OBC, and the first DC/DC converter L-DC through a power line and connected to a first controller Ctrl 1 through a signal line.

The first high voltage battery MB can include a sixth connector C6 that is separably connected to the fifth connector C5.

In the third mobility MLT 3 according to an embodiment, a space for mounting the first high-voltage battery MB can be provided, and as the first high-voltage battery MB can be mounted, and the fifth connector C5 can be connected to the sixth connector C6, the first high-voltage battery MB can serve as a power source of the power system.

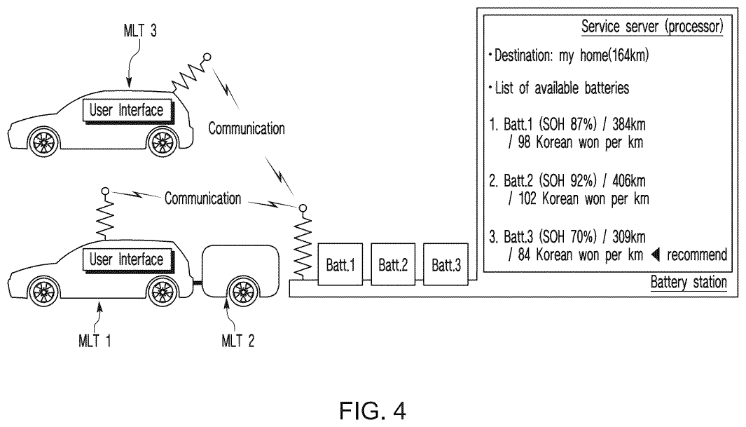

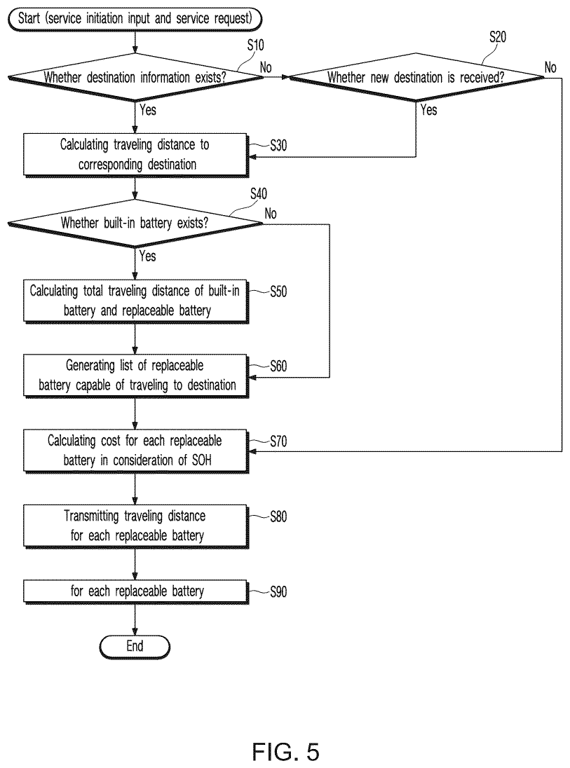

Hereinafter, a method for providing a battery replacement service according to an embodiment of the present disclosure will be described with reference to FIGS. 4 and 5.

In FIG. 4, the first mobility MLT 1 may receive a replacement service of the second high-voltage battery SB as the second mobility MLT 2 is replaced, and the third mobility MLT 3 may receive a replacement service of the first high-voltage battery MB of the third mobility MLT3. Alternatively, when the second high-voltage SB is detachably installed on the second mobility MLT 2, the first mobility MLT 1 may receive a service of separating and replacing only the second high-voltage battery SB from the second mobility MLT 2.

In this description, although a case when the first mobility MLT 1 receives a battery replacement service as the entire second mobility MLT 2 is replaced is limitedly described, this is merely for convenience of description, and an embodiment of the present embodiment is not necessarily limited thereto.

Alternatively, for convenience of description, the second high-voltage battery SB of the second mobility MLT 2 in a state of being connected to the first mobility MLT 1 may be referred to as a first swappable battery, and a swappable battery in a battery station, which will be described later, may be referred to as a second swappable battery. However, an embodiment of the present embodiment is not necessarily limited thereto.

Firstly, a plurality of second swappable batteries Batt 1, Batt 2, and Batt 3 and a service server can be disposed on a battery station of a business operator.

The second swappable battery may not be required to be matched with a manufacturer or specifications of the first swappable battery and can be usable as long as the second swappable battery is connected to the power system of the first mobility MLT 1.

The service server may include a memory in which a program for the battery replacement service can be stored and a processor that can execute a program.

The battery station may include a charger capable of charging each second swappable battery and further include an information collector capable of collecting state information from the BMS of each battery and transmitting the collected information to the service server. For example, the information collector may include a connection connector electrically connected to each battery, a buffer memory that temporarily stores the state information of the batteries, and a processor that identifies the state information for each battery and transmits the identified information to the service server.

The first mobility MLT 1 may include a user interface to perform the battery replacement service. For example, an AVN screen may be used as the user interface.

A program for the battery replacement service can be stored in the memory of the first controller Ctrl 1, and a processor of the first controller Ctrl 1 can execute the program to perform processes for the battery replacement service.

The battery replacement service according to an embodiment may be performed by, e.g., processes in FIG. 5.

When a user inputs service initiation through the user interface of the first mobility MLT 1, the first controller Ctrl 1 can transmit a service request for battery replacement to the service server through wireless communication.

The service request may include destination information.

For example, a navigation device of the AVN may contain the destination information input by the user, and the first controller Ctrl 1 may transmit the destination information in addition to the service request.

The service server can receive the service request and determine whether the destination information exists in an operation Si.

When the destination information is included, the service server can calculate a traveling distance to a destination in an operation S30.

For example, at least one of paths from the battery station to the destination may be determined to calculate the traveling distance. Also, for example, the service server may receive traveling path information from the first controller Ctrl 1 and determine the path from the battery station to the destination based on the traveling path information.

When no destination information exists in an operation S10, the service server may request the destination information from the first mobility MLT 1. When the navigation device has the destination information, the service server may transmit the information. When the destination information is not set in the navigation device, the first controller Ctrl 1 may request an input of the destination through the user interface.

When the service server receives new destination information (Yes in an operation S20), an operation S30 can be performed. Otherwise, an operation S70, which will be described later, can be performed.

The service server may determine whether a built-in battery exists in an operation S40.

The service server may request built-in battery information from the first controller Ctrl 1, and accordingly, the first controller Ctrl 1 may transmit information on the first high-voltage battery MB, e.g., SOC. Alternatively, the information on the first high-voltage battery MB may be included in and transmitted together with the above-described service request.

When the built-in battery exists, the service server can calculate a total traveling distance of each of the built-in first high-voltage battery MB and the available second swappable batteries in an operation S50.

Thereafter, the service server can generate a list of the second swappable batteries that satisfy the total traveling distance in addition to the first high-voltage battery MB in an operation S60.

The service server may calculate a usage cost based on SOH of respective second swappable batteries and allow the calculated usage costs to be included in the list.

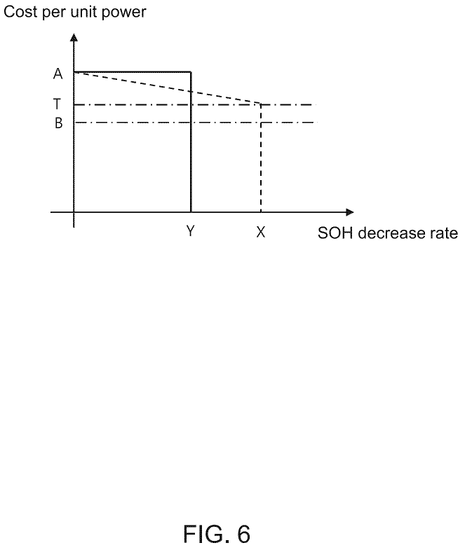

Hereinafter, one embodiment of a calculation of the usage cost based on the SOH will be described with reference to FIG. 6.

In FIG. 6, a reference symbol ‘A’ represents a highest battery rental cost. The highest cost may be a cost when the battery is a new product having a best SOH condition.

When the battery continues to be rented with a cost A regardless of a degree of aging, i.e., the SOH, users may avoid renting the battery, and a commercial usage lifespan of the battery may be reduced. Also, an average SOH of batteries that reach commercial usage lifespans thereof may be statistically determined.

When the battery continues to be rented with the cost A regardless of SOH, it may be determined that the battery reaches the commercial usage lifespan thereof when the battery reaches the above-described average SOH.

In FIG. 6, a reference symbol ‘Y’ represents a SOH decrease rate until a first SOH that is set based on the above-described average SOH. The Y may be calculated as ‘100% —first SOH’.

When a service is provided with a cost reduced based on the SOH, the commercial usage lifespan of the battery may be extended. For example, the business operator may set a SOH limit value and use the corresponding battery for service until the battery reaches the set SOH limit value. For example, the SOH limit value may be about 70%.

In FIG. 6, a reference symbol ‘X’ represents a SOH decrease rate until the SOH limit. That is, the X may be calculated by ‘100%—SOH limit value’.

In FIG. 6, a reference symbol ‘B’ represents a charging cost, and the business operator may determine the charging cost and in the charging cost to the service server.

Referring to FIG. 6, the service server may determine a minimum cost T through an equation below by using the Y determined based on the preset first SOH, the X determined by the preset SOH limit value, the preset maximum cost A, and the preset charging cost B:

$$\begin{matrix}( A - B ) Y \leq ( A - B ) X - \frac{1}{2} ( A - T ) X \\ T \geq 2 \frac{Y}{8} ( A - B ) + 2 B - A\end{matrix} .$$

Also, the service server may determine the cost by linearly decreasing the cost from the maximum cost A to the minimum cost T according to a decrease of the SOH.

The service server may transmit a list including a traveling distance, SOH, and cost information of each of the available swappable batteries to the first mobility MLT 1 in an operation S80.

The first controller Ctrl 1 may output the transmitted list through the user interface, and the user may select the second swappable battery to be replaced with the first swappable battery from the output list.

Based on the selection of the user, the first controller Ctrl 1 may transmit the selection to the service server, and thus, the service server may determine the corresponding second swappable battery as an object to be serviced in an operation S90.

A service operation process as in FIG. 5 may be performed in advance before the first mobility MLT 1 arrives at the battery station, and the first swappable battery may be replaced with the second swappable battery directly after the user arrives at the battery station.

According to an embodiment of the present disclosure, the demand of the customer on the traveling distance of the electric vehicle may be satisfied by adding the swappable battery in addition to the built-in battery or including the high-voltage battery in the swappable method instead of the built-in method.

Also, according to an embodiment of the present disclosure, as the charged cost of the swappable battery is varied depending on the SOH, the usage rate of the old battery may be increased, the consumers' satisfaction on the battery replacement service may be improved, and the business profit of the business operator may be increased.

The foregoing descriptions of specific example embodiments of the present disclosure have been presented for purposes of illustration and description. They are not intended to be exhaustive or to necessarily limit the present disclosure to the precise forms disclosed, and obviously many modifications and variations can be possible in light of the above teachings. The example embodiments were chosen and described to explain certain principles of the present disclosure and their practical application, to enable others skilled in the art to make and utilize various example embodiments of the present disclosure, as well as various alternatives and modifications thereof. It is intended that the scopes of the present disclosure be defined by the Claims appended hereto and their equivalents.

What is claimed is:

1. A method for providing a battery replacement service that provides a second swappable battery to replace a first swappable battery for a mobility, wherein the mobility includes a plurality of wheels, at least one driving motor configured to provide driving force to the plurality of wheels, a power system configured to supply power to the driving motor, and the first swappable battery being detachably connected to the power system, the method comprising:
receiving, by a service server, a service request from a user terminal;
transmitting, by the service server, a list of available swappable batteries to the user terminal according to the service request; and
receiving, by the service server, selection of one of the available swappable batteries in the list from the user terminal and determining the second swappable battery according to the received selection.

2. The method of claim 1, wherein the transmitting of the list of the available swappable batteries to the user terminal comprises:
determining a cost for each of the available swappable batteries based on a state of health (SOH) thereof; and
including the determined cost in the list of the available swappable batteries.

3. The method of claim 2, wherein the determining of the cost comprises determining the cost to be decreased linearly as the SOH is decreased.

4. The method of claim 3, wherein the determining of the cost to be decreased linearly as the SOH is decreased comprises:
determining a minimum cost by using a first SOH, a SOH limit, a maximum cost, and a charging cost; and
determining the cost by decreasing the cost linearly from the maximum cost to the minimum cost as the SOH is decreased.

5. The method of claim 1, wherein the service request comprises destination information; and
wherein the transmitting of the list of the available swappable batteries to the user terminal comprises:
determining a traveling distance according to the destination information, and
determining the available swappable batteries according to the traveling distance.

6. The method of claim 5, wherein the power system comprises a first high-voltage battery that is fixedly installed on the mobility,
wherein the first swappable battery comprises a second high-voltage battery that is detachably connected to the power system to supply power to the first high-voltage battery, and
wherein the determining of the available swappable batteries according to the traveling distance comprises determining the available swappable batteries based on an SOC of the first high-voltage battery.

7. The method of claim 5, wherein the first swappable battery comprises a first high-voltage battery that is detachably connected to the power system to supply power to the at least one driving motor, and
wherein the determining of the available swappable batteries according to the traveling distance comprises determining swappable batteries that satisfy the traveling distance as the available swappable batteries.

8. The method of claim 1, wherein the list of the available swappable batteries comprises a SOH, a traveling distance, and a cost for each of the available swappable batteries.

9. A service server for a battery replacement service, the server comprising:
one or more processors; and
a storage medium storing computer-readable instructions for the battery replacement service that, when executed by the one or more processors, enable the one or more processors to:
receive a service request from a user terminal, wherein the service request relates to providing a second swappable battery to replace a first swappable battery for a mobility, wherein the mobility includes a plurality of wheels, at least one driving motor configured to provide driving force to the plurality of wheels, a power system configured to supply power to the driving motor, and the first swappable battery detachably connected to the power system,
transmit a list of available swappable batteries to the user terminal according to the service request,
receive selection of one of the available swappable batteries in the list from the user terminal, and
determine the second swappable battery according to the received selection.

10. The server of claim 9, wherein the instructions further enable the one or more processors to:
determine a cost for each of the available swappable batteries based on a state of health (SOH) thereof; and
include the determined cost in the list of the available swappable batteries.

11. The server of claim 10, wherein the instructions further enable the one or more processors to determine the cost to be decreased linearly as the SOH is decreased.

12. The server of claim 11, wherein the instructions further enable the one or more processors to:
determine a minimum cost by using a first SOH, a SOH limit, a maximum cost, and a charging cost; and
determine the cost by decreasing the cost linearly from the maximum cost to the minimum cost as the SOH is decreased.

13. The server of claim 9, wherein the service request comprises destination information, and wherein the instructions further enable the one or more processors to:
determine a traveling distance according to the destination information; and
determine the available swappable batteries according to the traveling distance.

14. The server of claim 13, wherein the power system comprises a first high-voltage battery that is fixedly installed on the mobility,
wherein the first swappable battery comprises a second high-voltage battery that is detachably connected to the power system to supply power to the first high-voltage battery, and
wherein the instructions further enable the one or more processors to determine the available swappable batteries based on a SOC of the first high-voltage battery.

15. The server of claim 13, wherein the first swappable battery comprises a first high-voltage battery that is detachably connected to the power system to supply power to the at least one driving motor, and
wherein the instructions further enable the one or more processors to determine the available swappable batteries as ones that satisfy the traveling distance.

16. The server of claim 9, wherein the list of the available swappable batteries comprises a SOH, a traveling distance, and a cost for each of the available swappable batteries.

17. A mobility comprising:
a plurality of wheels;
at least one driving motor configured to provide driving force to the plurality of wheels;
a power system configured to supply power to the driving motor;
a first swappable battery that is detachably connected to the power system;
a user interface;
a wireless communication module; and
a first controller configured to communicate with a service server for a battery replacement service through the wireless communication module according to an input of a user through the user interface,
wherein the first controller is configured to transmit a service request to the service server according to the input of the user through the user interface, receive a list of available swappable batteries from the service server, and transmit selection of one of the available swappable batteries in the list selected through the user interface by the user to the service server.

18. The mobility of claim 17, wherein the power system comprises a first high-voltage battery that is fixedly installed on the mobility, and
wherein the first swappable battery comprises a second high-voltage battery that is detachably connected to the power system to supply power to the first high-voltage battery.

19. The mobility of claim 17, wherein the first swappable battery comprises a first high-voltage battery that is detachably connected to the power system to supply power to the at least one driving motor.

20. The mobility of claim 17, wherein the list of the available swappable batteries comprises a SOH, a traveling distance, and a cost for each of the available swappable batteries.
